(19) United States
(12) Patent Application Publication
(10) Pub. No.: US 2014/0316795 A1
(43) Pub. Date: Oct. 23, 2014

(54) METHOD FOR MANAGING FIRST AND SECOND AUTHENTICATORS LOADED IN A DEVICE FOR INFORMING ABOUT AND MONITORING THE TAKING OF A SPECIALITY BY A PATIENT

(71) Applicant: Medimind, Corroy-Le-Grand (BE)

(72) Inventors: Bernard HIERNAUX, Corroy-Le-Grand (BE); Frederic LECLERCQZ, Oisquercq (BE)

(73) Assignee: Medimind, Corroy-Le-Grand (BE)

(21) Appl. No.: 14/255,227

(22) Filed: Apr. 17, 2014

(30) Foreign Application Priority Data
Apr. 18, 2013 (BE) 2013/0280

(51) Int. Cl. G06F 19/00

(52) U.S. Cl. CPC G06F 19/3456
USPC 705/2

(57) ABSTRACT

Method for managing a first and second authenticator in a device for informing about and monitoring a taking of a speciality by a patient, the method comprising the steps of: using the first authenticator to verify the patient data, to take from a database the second authenticators linked to the first authenticator containing a list of specialities, adapting the speciality and the dosage thereof, sending a set of data containing the adapted list of second authenticators to the management unit, preparing a sequence of alerts on the basis of the second authenticators and by the management unit.

The present invention concerns a method for managing first and second authenticators loaded in a device for informing about and monitoring the taking of a speciality by a patient, comprising the connection to a database of the device having, in a first part of a memory, data of the patient present in the first authenticator.

A very large number of persons are obliged to take one or a more medications per day in order to manage one or more health problems. Monitoring a treatment and managing the taking of one or more medications and their dosage in an optimum manner involves strong discipline and constancy on the part of the patient. Likewise regular monitoring on the part of the doctor is necessary to monitor the results in the development of an illness and/or the cure, especially in the cases of serious illnesses. The problem does not concern only the drugs prescribed by a doctor or the medical profession but also concerns other substances that a patient may take and therefore in the remainder of the text the word speciality will be used to indicate both a drug subject or not to prescription, and a product delivered in a pharmacy and not registered as a drug.

The patent application US 2013/0085767 discloses a method and an electronic device for managing medical treatment that assist the patient under treatment to manage his treatment. The patient is informed by an electronic calendar of the time at which he or she must take a drug. Thus the patient receives a reminder that helps him to comply with his treatment.

In the method according to the prior art, the patient connects the electronic device to a network and downloads from a database one or more lists of specialities, prescribed or not by the doctor, as well as the calendar for programming the frequency at which the specialities should be taken, selecting the time and the day of the week.

The patient can choose the treatment and the dosage of his preference, combine various treatments, and select the brand of a speciality.

The method disclosed functions under a master-slave regime where the master is the patient and the slave is the database from where the patient downloads the information necessary for programming the device. The fact that the patient has the possibility of programming and managing the device poses a problem for complying with the prescription of the doctor, this mainly in the cases where the success of the treatment depends highly on his compliance with his prescription.

There is therefore a need to ensure that the patient cannot manipulate the information relating to the treatment.

The aim of the invention is to propose a method that makes it possible to programme the device independently of the patient while guaranteeing the link between the patient and his dosage.

To this end the method according to the invention comprises the connection to a database of the device having, in a first part of a memory data of the patient recorded in the first authenticator,
said method is characterised in that it comprises the steps of:
checking, at a management unit connected to the database, that the first authenticator is present in the database;
communicating, from the management unit to an interface housed with a person who is attending to the health of the patient, that the first authenticator is stored in the device;
using the first authenticator to check the data of the patient and to take from the database a list of the second authenticators linked to the first authenticator and comprising a list of specialities in the database;
communicating to the person from the management unit the list of second authenticators;
the adaptation, by said person, of the speciality or specialities and their dosage, and sending a set of the data comprising the adapted list of the second authenticators to the management unit;
preparing, on the basis of the second adapted authenticators and by means of the management unit, a sequence of the alerts to be produced by the device, and storing the sequence of alerts in the database;
transmitting, by means of the management unit, the sequence of alerts to the interface;
synchronising, by means of the management unit, the set of data and the sequence of alerts stored in the database with the device, and thereafter communicating to the interface that the device is ready for use.

The method according to the invention functions under a master-slave regime where the master is now formed by the management unit and the interface housed with the person. The slave is now the patient, who does not have access to the unit and therefore to the programming of the device.

Advantageously, the method according to the invention is characterised in that, if the first authenticator is not stored in the database or in the device, the person will authenticate the patient and transmit the patient data by means of the interface to the management unit, the management unit then forms, by means of the patient data, the first authenticator and stores it in the database. The authentication of the patient makes it possible to initiate the activation of the device and to link it uniquely to the patient for whom the speciality to be taken has been prescribed. Thus the person can ensure that the patient to whom the device belongs and the one to whom the speciality has been prescribed are indeed the same person. In addition, the personalisation of the device also makes it possible better to comply with the requirements with regard to medical confidentiality.

Advantageously, the method according to the invention is characterised in that the list of second authenticators is formed by introducing therein a dose and a galenic form of the speciality to be taken by the patient, and introducing therein the sequence of alerts formed by the time or times of the day at which said dose of the speciality must be taken. The galenic form of the speciality helps to determine the quantity of speciality to be taken in order to comply with the dose prescribed and guarantee the effect required by the treatment.

Advantageously, the method according to the invention is characterised in that the list of second authenticators is formed by introducing therein also the quantity of each speciality that has been supplied to the patient, and in that a renewal signal is produced when the remaining quantity of the dose of specialities is less than a predetermined quantity. This enables the patient to do what is necessary in good time so that he does not lack one or more specialities that have been prescribed for him.

Advantageously, the method according to the invention is characterised in that a list of validations is formed from the list of second authenticators and the validation made by the patient whenever he has taken the speciality, said list is stored in the device. As the patient is called on to confirm the taking of the dose indicated, the device can not only store the information that the dose has actually been taken but also, with the agreement of the patient, communicate it to the person, who can thus better monitor compliance with the dosage by the patient.

The invention will now be described in more detail with the help of the drawings, which illustrate a preferred embodiment of a communication network and of the device for informing about and monitoring the taking of a speciality (on the basis of the dosages) prescribed or recommended to a patient. In the drawings:

### BRIEF DESCRIPTION OF THE DRAWINGS

FIG. 1 illustrates schematically the communication network and the various components thereof;

FIG. 2 illustrates schematically how the communication is made in the communication network;

FIG. 3 illustrates the activation of the device for informing about and monitoring the taking of a speciality (on the basis of dosages) prescribed or recommended to a patient;

FIGS. 4A and 4B illustrate the loading of the dosage into the device; and

FIG. 5 illustrates the function of the device.

In the drawings the same reference has been allocated to the same element or to a similar element.

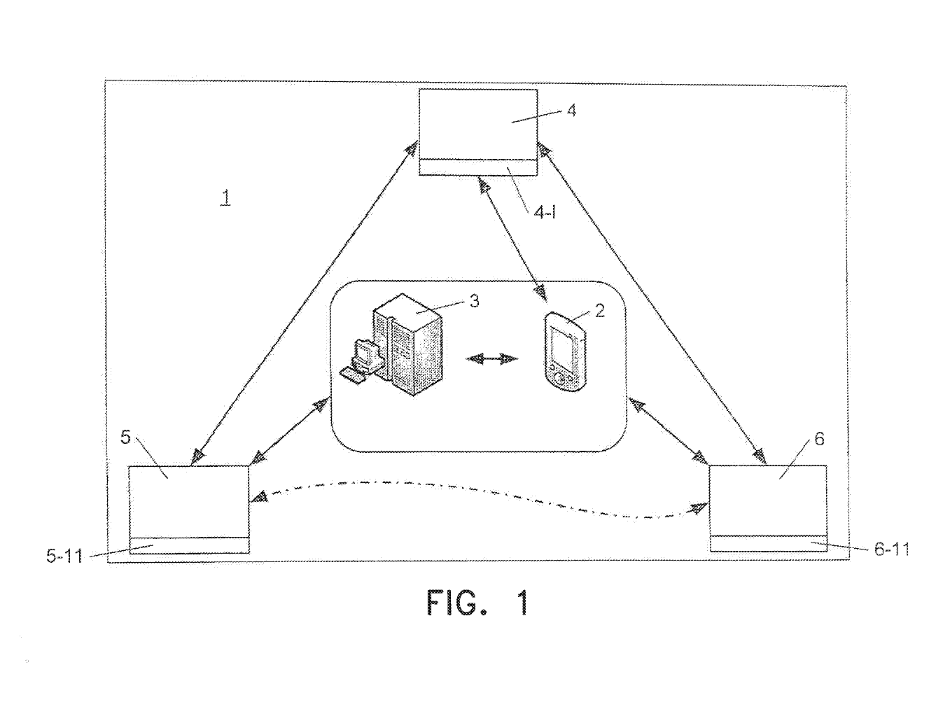

FIG. 1 illustrates an example of a network 1 for communicating information concerning specialities and their dosages of a first set of patients. In this network three persons fulfil an important role, namely the patient 4, his treating doctor 5 and his pharmacist 6. Naturally the doctor 5 is not necessarily formed by a single person and comprises the set of doctors or other persons who are taking care of the health of the patient 4, in particular the generalist, the specialist or specialists and the dentist. The same applies for the pharmacist 6, who may be not only the usual pharmacist of the patient, but for example also the duty pharmacist.

In the communication network 1 according to the invention each patient 4 has a device 2 for informing about and monitoring the taking of a speciality by a patient 4. For reasons of medical confidentiality, the device 2 is in each case linked to a single patient. The device 2 is connected to a management unit 3, which is housed with the manager of the communication network. The doctor 5 has a first interface 5-11 and the pharmacist 6 has a second interface 6-11. The first and second interfaces make it possible to establish a communication between the device 2, the doctor 5, and respectively the pharmacist 6 and the management unit 3. These interfaces 11 may for example be formed by a computer connected to the internet or by a telephone. The device 2 for its part is provided with a communication unit, which is either fully integrated in the device 2 or cooperates with a computer connected to the internet or to a telephone. The communication unit enables communication with the first and second interfaces as well as with the management unit 3.

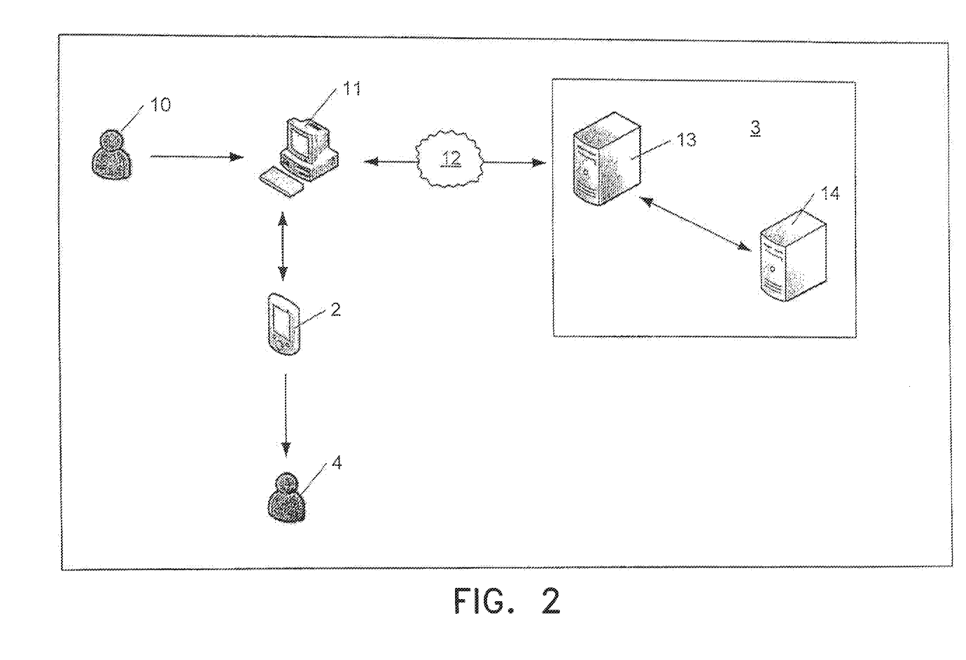

FIG. 2 illustrates schematically how the communication is performed in the communication network 1 according to the invention. A user 10, who is either the doctor 5 or the pharmacist 6 of the patient 4 to whom the device 2 belongs, can enter into communication with the device 2 by means of his interface 11. The latter is connected to the management unit 3, for example via the internet or the telephone 12. The management unit 3 preferably comprises an application server 13 and a database 14. The latter is arranged to store firstly data for authenticating the patients that are the proprietors of a device 2 and secondly data relating to the specialities and the dosages thereof taken by each of these patients. The communication between the device 2 and the interface 11 can be done for example by means of a cable or by wireless. Communication by cable makes it possible to better safeguard the confidentiality of the data transmitted, but it will be clear that, when the communication is done by wireless, confidentiality may be safeguarded by encrypting the data.

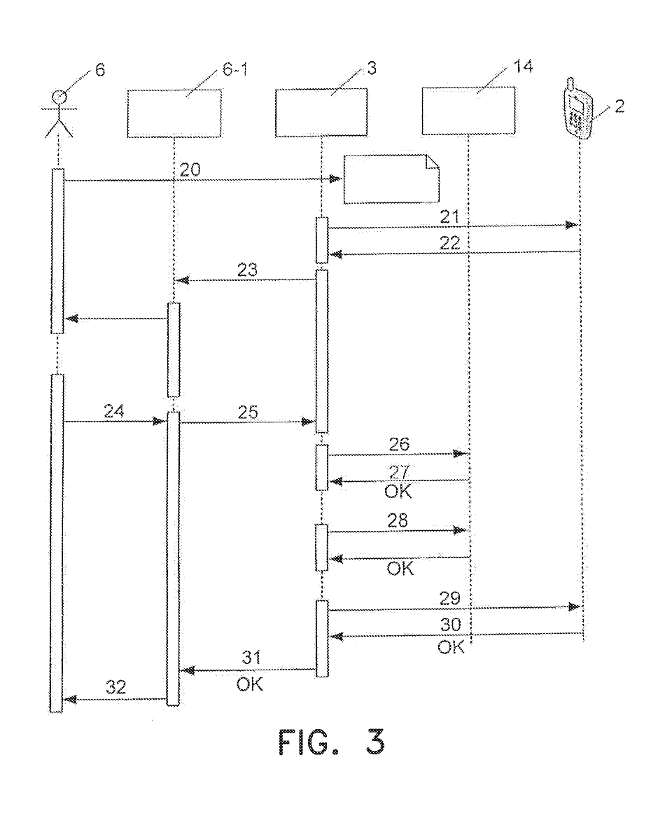

FIG. 3 illustrates the activation of the information monitoring device 2. When the patient 4 for whom his doctor 5 has prescribed one or more specialities and their dosage wishes to have available a device 2 for informing about and monitoring the taking of a speciality (on the basis of the dosages), he can for example go to his pharmacist 6 in order to activate his device 2. Naturally the doctor 5 could also be responsible for such activation. This activation is important since it makes it possible to personalise the device 2 and to link it to the patient 4 for whom the speciality to be taken has been prescribed. Thus the doctor 5 and the pharmacist 6 can ensure that the patient 4 to whom the device 2 belongs and the person for whom the specialities have been prescribed are indeed the same person. Furthermore, the personalisation of the device 2 also makes it possible to better comply with the requirements with regard to medical confidentiality.

The device 2 comprises a memory having a first and second part. The first part is arranged so as to store therein a first authenticator authenticating the patient for whom the speciality or specialities are intended. The second part is arranged so as to store therein a list of second authenticators, said second authenticators each authenticating a dose and a galenic form of a speciality to be taken by the patient 4 as well as the time or times of day at which said dose of the speciality must be taken by the patient 4. For example, for patient A, it will be prescribed that each morning preferably at a precise time he should take a 5 mg tablet of a speciality B.

When the patient 4 has purchased a device 2 according to the invention, his pharmacist 6 or his doctor 5 will, by means of its interface 11, get into contact with the management unit 3. For reasons of clarity, the rest of the description will be described starting from the example that it is the pharmacist 6 who proceeds with the initialisation.

The pharmacist 6 will connect 20 the device 2 to his interface 11 and initiate the communication with the management unit 3. The management unit 3 will then request 21 the device 2 to authenticate itself. As the device 2 is not yet initialised it cannot authenticate itself and sends 22 a message to the interface 11 indicating this. The unit 3 will then initiate the initialisation process for a new patient 4 and request 23 the pharmacist 6 to make known the patient 4, for example by means of his surname and first name, date of birth, address, etc. All these data then form the basis for forming a first authenticator. After the pharmacist 6 has communicated 24 all the patient data, they are sent 25 to the management unit 3, which will store them 26 in the database 14. When the data are received and stored, the management unit 3 then sends 27 a confirmation. Next the unit 3 will produce 28 the first authenticator and store it in its database 14. Next the first authenticator will be transmitted 29 to the device 2, which will store it in the first part of the memory. After this the device 2 will communicate 30 to the unit 3 that the first authenticator has been stored in its memory. When the storage both in the database 14 and in the first part of the memory has been effected successfully, the management unit 3 produces 31 information as to how the registration has succeeded and informs 32 the pharmacist 6 thereof.

Where applicable the patient could also initialise his device 2 by using the internet by connecting to the site of the unit 3.

During this visit or during a future visit to his doctor 5 or his pharmacist 6, the patient 4 will then hand him his device 2. By means of his interface 11 and the device 2 of the patient, the doctor 5 or the pharmacist 6 can then get in communication with the management unit 3. The doctor 5 or the pharmacist 6 can also verify, by means of the first authenticator, that the device 2 actually belongs to the patient 4.

After the doctor 5 has consulted with the patient and he considers that the patient 4 needs a treatment, he will prescribe one or more specialities and their dosage. This speciality or specialities and the dosage thereof must then be communicated to the management unit 3 by the doctor 5 so as to be stored in the database 14. The dosage and the speciality or specialities prescribed will be associated with the first authenticator and will be stored in the database 14. Naturally the doctor 5 can also enter the speciality or specialities and the dosage thereof on a sheet of paper and hand it to the patient 4, who will then give it to his pharmacist 6 so that the latter can perform the operation of storage in the database 14.

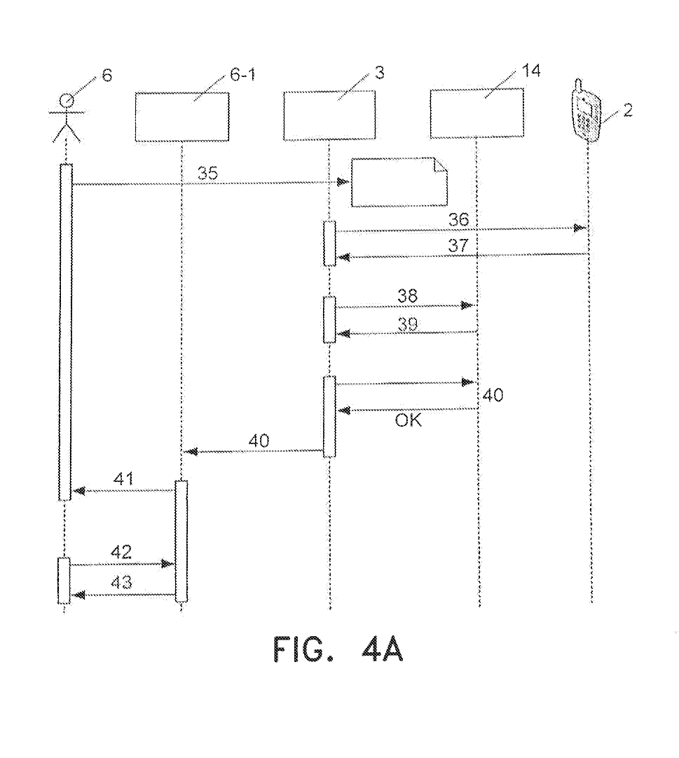

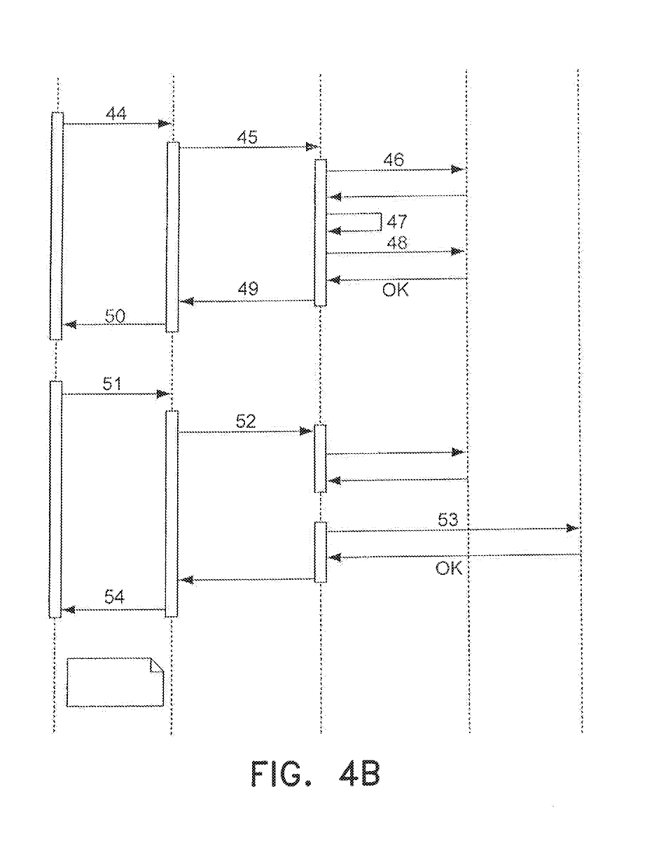

After having visited his doctor 5, the patient 4 will be able to go to his pharmacist 6 in order to seek the specialities prescribed. The latter will then be responsible for storing the speciality or specialities and the dosage thereof in the second part of the memory. Here it will be assumed, once again for reasons of clarity, that it is the pharmacist 6 who will be responsible for storing the speciality or specialities and the dosage thereof. FIGS. 4A and 4B illustrate the various steps for loading the speciality or specialities and the dosage thereof in the device 2. The patient 4 will hand over his device 2 as well as the prescription from the doctor 5 to the pharmacist 6. The pharmacist 6 will connect 35 the device 2 to his interface 11 and establish a connection with the management unit 3. The interface 11 will read 36 the first authenticator in the first part of the memory of the device 2 and where applicable the list of validations made by the patient 4 whenever he or she has taken the speciality. These data will then be sent 37 to the unit 3. The latter will seek 38 in its database 14 this first authenticator in order to take the patient data and the list of second authenticators in order to send them 39 to the unit 3. This list of specialities, the validations taken and the first authenticator will be sent to the unit 3. The latter will then store 40 the list of validations in the database 14 and verify the data of the patient 4.

After verification 40 of the patient data the data will be displayed 41 with the pharmacist 6. After this, the pharmacist 6 can then check that the device 2 actually belongs to the patient 4 for whom the speciality and the dosage thereof has been prescribed. If such were not the case, the transaction will be interrupted. Thus the pharmacist 6 can check that there is agreement between the device 2 and the patient 4 for whom the speciality and the dosage thereof has been prescribed.

After the authentication has been validly carried out, the pharmacist 6 will request 42 a display of a form for entering the speciality or specialities and the dosage thereof prescribed by the doctor 5, and said form will then be displayed 43. The pharmacist 6 can then encode 44 in the form the speciality or specialities and the dosage thereof prescribed by entering therein not only the brand of the speciality but also the galenic form thereof and the dose to be taken at the times indicated. The pharmacist 6 will also encode the quantity of each speciality that he has given to the patient. Where applicable the pharmacist 6 could encode, in place of the speciality of a certain brand prescribed by the doctor 5 that he has given, a speciality of another brand having of course the same active principle. All these data introduced by the pharmacist 6 will then be sent 45 to the management unit 3 in order to be stored 46 therein in the database 14.

After reception of the data encoded by the pharmacist 6 and storage thereof in the database 14, the unit 3 will process them in order to prepare 47 the sequence of alerts to be produced by the device 2. This sequence of alerts will be stored 48 in the database 14 and transmitted 49 to the interface 11 of the pharmacist 6 in order to be displayed 50 therein. The pharmacist 6 will then request 51 the unit to synchronise 52 the list stored in the database 14 with the device 2 and to enter 53 the list of specialities and the sequence of alerts in the second part of the memory.

After this writing in the second part of the memory the unit 3 will send 54 a message to the pharmacist 6 that the writing has ended and that he can hand the device 2 to the patient 4. Naturally this process will be repeated whenever either the dosage has changed or the speciality or specialities have changed and whenever the patient 5 comes to renew the specialities with his pharmacist 6.

In the example described above it is the unit 3 that prepares the sequence of alerts. Naturally it would also be possible to provide the device 2 with a more powerful processor and the ability to determine the sequence of alerts.

The device 2 according to the invention comprises a clock that is connected to the communication unit of the device 2. On the basis of the list of specialities and the sequence of alerts loaded in the second part of the memory, the device 2 will, by means of its clock, monitor the time in order to check when the time has come to take one or more specialities. The time may be a precise time if the dosage so prescribes, but it may also be a time range that the patient 4 or pharmacist 6 can himself specify, such as for example the morning or evening. Thus, if the speciality must for example be taken solely in the morning, or at each mealtime, the patient can communicate his suitable time ranges to the pharmacist 6.

The communication unit of the device 2 thus comprises a signal generator connected to the clock. When the clock indicates a time that corresponds to one of those entered in the sequence of alerts, the signal generator detects it and produces an information signal. If the sequence of alerts comprises several of these times per day, naturally the signal generator will detect each of these times of the day and on each occasion produce an information signal. The latter can be produced in several forms according to the implementation of the device. Thus the device 2 can be equipped with a display screen on which the speciality or specialities are shown and the dose to be taken, and where applicable also the galenic form thereof, will be entered. This display can be done for example by mentioning the name of the speciality or specialities, or showing a photograph of the box and/or of the actual speciality. Where applicable the display may be accompanied by an audible and/or vibrating and/or light signal.

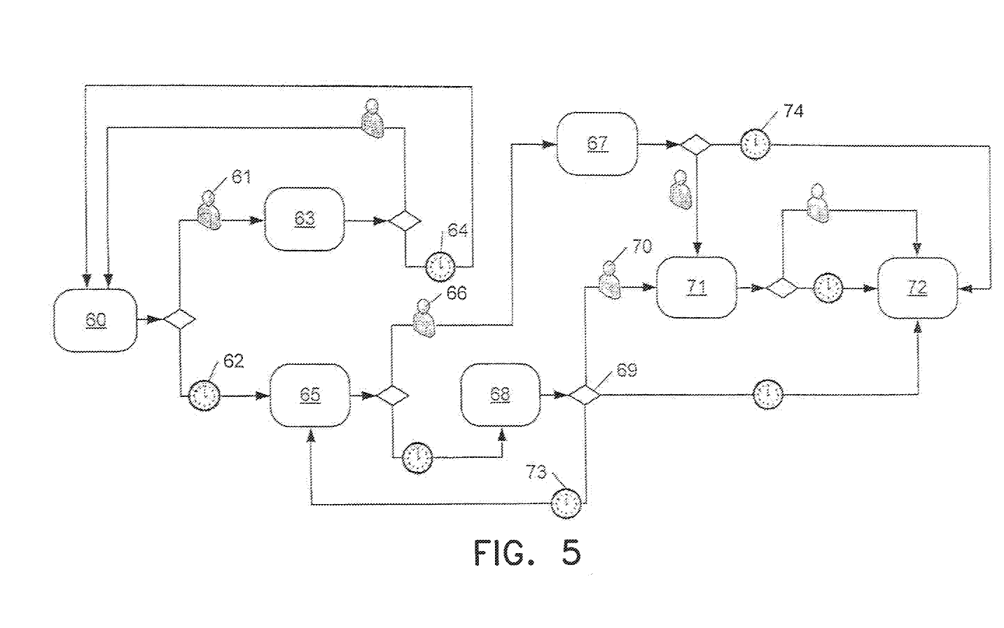

The production of this information signal will now be described in more detail by means of an example set out in FIG. 5. The device 2 is normally on standby 60 and can be activated either by the patient 61 himself or by a person in a medical service, or by the clock 62, which cooperates with the list of specialities and the sequence of alerts stored in the memory. When the patient or said person has activated the device, the latter will display 63 the specialities and the time ranges stored and return 64 to standby after a predetermined time. If on the other hand it is a clock that has activated the device 2, an audible and visual information signal will be produced 65. If the patient presses 66 on a stop button provided for this purpose, the audible signal will stop 67 so as not to inconvenience the patient and only the display will be maintained. If the patient does not himself stop the audible signal, the latter switches off 68 after a predetermined time, for example 40 seconds. The device will then check 69 whether the patient validates 70 that he has indeed taken the speciality or specialities set out in the message displayed. If such is the case the device will store 71 the fact that the patient has indicated to it that he has taken these specialities and the device goes to standby 72. If on the other hand the patient has not informed the device that he has taken his specialities, the device will once again produce an audible signal 73 in order to remind the patient that he must validate the taking of the specialities. The latter reminder is repeated on several occasions so that the patient can validate the taking of the specialities. If the patient does not validate the taking, the production of the signal will be stopped 74 and it will be recorded in the second part of the memory that the patient has not validated the taking.

By deactivating the call generator, the patient indicates to the device 2 that he has received the message that he should take his speciality or specialities and that he or she has actually taken them. The deactivation of the call generator is stored in the memory, for example in the second part or in another part reserved for this purpose. Thus the device 2 can store the response supplied by the patient.

The fact that the response supplied by the patient is stored in the memory of the device will subsequently enable the doctor 5 to best check that the patient 4 has actually complied with the dosage that the doctor 5 had prescribed for him. Even if the patient 4 validates the taking of the speciality without actually having taken it, the fact of having to validate the call generator will make the patient 4 responsible who will wish, faced with his doctor 5, to keep a good conscience and will therefore not attempt to falsify the information. In addition, the patient knows that the doctor 5 can easily, be means of a blood or urine sample, check that he has actually taken the prescribed dose. The device 2 according to the invention thus enables the doctor 5 best to monitor his patient 4 and thus to be best informed that the specialities that he has prescribed actually have their effect.

The fact that the response provided by the patient 4 is stored in the memory of the device 2 also makes it possible to compare, by means of a comparison unit connected to the memory and to the information generator, the number of specialities taken with the number supplied by the pharmacist 6. Thus the comparison unit can produce a renewal signal when the remaining quantity is less than a predetermined quantity, which enables the patient 4 to renew his dose of specialities in good time.

The device 2 also comprises an intervention command that, for example at the time of an accident or during an emergency medical intervention, enables the personnel who will care for the patient to know the specialities that the patient is taking. This is because, as the list of specialities is stored in the memory, activation of this intervention command will enable reading of the memory and display of the list of specialities, posologies and dosages as well as certain information specifically required by the patient and encoded by the pharmacist, such as for example the telephone number of a relative or his doctor, or his Rhesus factor. This then enables said personnel to know exactly the specialities of the patient and to act in knowledge of the case.

1. Method for managing a first and second authenticator loaded in a device (2) for informing about and monitoring the taking of a speciality by a patient (4), said method comprising the connection (35) to a database (14) of the device (2) having, in a first part of a memory, data of the patient entered in the first authenticator;
said method is characterised in that it comprises the steps of
checking, at a management unit (3) connected to the database (14), that the first authenticator is present in the database (14);
communicating (40), from the management unit (3) to an interface (11) housed with a person who is attending to the health of the patient, that the first authenticator is stored in the device (2);
using (38) the first authenticator to check the data of the patient (4) and to take from the database (14) a list of the second authenticators linked to the first authenticator and comprising a list of specialities in the database (14);
communicating (4:0 to the person from the management unit (3) the list of second authenticators;
the adaptation (44), by said person, of the speciality or specialities and their dosage, and the sending (45) of a set of the data recording the adapted list of the second authenticators to the management unit (3);
preparing (47), on the basis of the second adapted authenticators and by means of the management unit (1), a sequence of the alerts to be produced by the device (2), and storing (48) the sequence of alerts in the database (14)
transmitting (49), by means of the management unit, the sequence of alerts to the interface (11);
synchronising (52), by means of the management unit (3), the set of data and the sequence of alerts stored in the database (14) with the device (2), and thereafter communicating (54) to the interface (11) that the device (2) is ready for use.

2. Method according to claim 1, characterised in that, if the first authenticator is not stored in the database in the device (2), the person will authenticate the patient (4) and transmit (20) the patient data by means of the interface (11) to the management unit (3), the management unit (3) then forms (23), by means of the patient data, the first authenticator and stores (26) it in the database (14).

3. Method according to claim 1, characterised in that the list of second authenticators is formed by introducing therein a dose and a galenic form of the speciality to be taken by the patient (4), and introducing therein the sequence of alerts formed by the time or times of the day at which said dose of the speciality must he taken.

4. Method according to claim 3, characterised in that the list of second authenticators is formed by introducing therein also the quantity of each speciality that has been supplied to the patient (4) and in that a renewal signal is produced when the remaining quantity of the dose of specialities is less than a predetermined quantity.

5. Method according to claim 1, characterised in that the time or times to take one or more specialities set out in the list of specialities is or are detected and checked, by means of a clock, from the sequence of alerts.

6. Method according to claim 5, characterised in that an information signal is produced from a signal generator connected to the clock when the time or times to take a speciality are detected.

7. Method according to claim 1, characterised in that a list of validations is formed from the list of second authenticators and the validation done by the patient (4) whenever he has taken the speciality, said list is stored in the device (2).

8. Method according to claim 6, characterised in that, if the patient (4) does not validate the taking of the speciality, the generator will once again produce a signal for reminding the patient (4) that he must validate the taking or the specialities informed about.

9. Method according to claim 8, characterised in that, if the patient (4) does not validate the taking after a further production of the signal, the production of the signal will be stopped and it will be recorded in the second part of the memory that the patient (4) has not validated the taking.

10. Method according to claim 1, characterised in that the name of the speciality or specialities to be taken is displayed, by showing a photograph of the box and/or of the speciality itself or the specialities themselves.

11. Method according to claim 1, characterised in that communication is made to the person by communicating either to a treating doctor, or a set doctors, or a generalist, or the specialist or specialists, or the dentist, or the usual pharmacist of the patient, or the duty pharmacist.

12. Method according to claim 1, characterised in that, as the speciality, either a medication subject or not to a prescription, or a product delivered in The pharmacy and not recorded as a medication, is taken.
